(19) United States
(12) Patent Application Publication
(10) Pub. No.: US 2018/0141786 A1
(43) Pub. Date: May 24, 2018

(54) System and Method for Hanging Fence Gates

(71) Applicant: Emerapearl, LLC, Rush Springs, OK (US)

(72) Inventor: Daniel Harrison, JR., Rush Springs, OK (US)

(21) Appl. No.: 15/813,927

(22) Filed: Nov. 15, 2017

Related U.S. Application Data
(60) Provisional application No. 62/424,838, filed on Nov. 21, 2016.

(51) Int. Cl. B66C 1/14; B66C 13/20; E04H 17/26; B66C 1/42; B66C 13/08

(52) U.S. Cl. CPC B66C 1/14; B66C 13/20; B66C 13/08; B66C 1/422; E04H 17/26

(57) ABSTRACT

A system and method for single-handedly hanging a gate on a gate post. The system comprises a pair of A-frames, each comprising a pair of legs hingedly attached at an apex. Each of the legs has a stabilizing foot on its free end. A flexible and length-adjustable hanger is suspended from the apex between the legs. The gate is positioned upright adjacent the gate post, and then the A-frames are positioned over the gate so that they straddle the gate and are spaced apart. Next, the hangers are attached to the gate to elevate the gate at the correct height. The gate can be leveled by adjusting the distance between the feet of each of the A-frames. Once leveled, the gate hardware can be connected to the post hardware. Then, the A-frames are removed. All this can be done easily and safely by a single person.

### CROSS-REFERENCE TO RELATED APPLICATIONS

This application claims the benefit of U.S. provisional application No. 62/424,838 entitled “System and Method for Hanging Fence Gate,” filed Nov. 21, 2016, the contents of which are incorporated herein by reference.

### FIELD OF THE INVENTION

The present invention relates to fencing generally and, more particularly but without limitation, to hanging fence gates.

### BRIEF DESCRIPTION OF THE DRAWINGS

The accompanying drawings, which are incorporated into and form a part of the specification, illustrate one or more embodiments of the present invention and, together with this description, serve to explain the principles of the invention. The drawings merely illustrate a preferred embodiment of the invention and are not to be construed as limiting the scope of the invention.

FIG. 1 is a frontal view of a gate hanger system constructed in accordance with a preferred embodiment of the present invention. The system comprises a pair of similarly constructed A-frames that are shown straddling and suspending a triple wide agricultural gate adjacent the fence post to which the gate will be mounted.

FIG. 2 is a side view of the gate hanger system showing the A-frames side by side and illustrating the hangers.

FIG. 3 is a perspective view of one of the A-frames. The hanger is omitted to simplify the illustration.

FIG. 4 is an enlarged, exploded view of the apex of the A-frame. The hanger is omitted to simplify the illustration.

FIG. 5 is an enlarged, fragmented view of the apex showing the pivotally attached tab by which the chain hanger is adjustably supported at the apex.

FIG. 6 is an enlarged, exploded view of the joint in one of the legs of the A-frame.

FIG. 7 is an enlarged, exploded view of the joint between the lower end of one of the legs of the A-frame and the foot.

FIG. 8 is an enlarged, fragmented view of an A-frame with the hook supporting one end of the fence gate.

### DETAILED DESCRIPTION OF THE PREFERRED EMBODIMENT(S)

Hanging a wide fence gate requires that the gate be supported and leveled adjacent the gate post while the hinge hardware on the gate is engaged with the hardware on the post. This is a simple process when two people are involved—one to hold the fence gate while the other connects the hardware. However, when only one individual is available, the task is problematic, especially where the gate is a metal agricultural gate that is 16-20 feet wide and weighs in excess of 100 pounds. A single person must somehow support the gate in an upright position while at the same time elevating it several inches off the ground so that it is level with the hinge hardware on the gate post. This process is not only frustrating but can be hazardous as well. For example, the gate may shift against the post and injure the installer's hands while he is connecting the hinge hardware. Additionally, trying to maneuver the gate while connecting the hinge hardware may result in back injuries or muscle strains. Still further, a heavy metal gate falling off make-shift supports may damage nearby vehicles or injure ranch animals. These difficulties and hazards are remedied by the present invention. The system and method of the present invention allow a single person to easily elevate and align even the widest agricultural gates. The system maintains the gate in the correct position, while still allowing minor adjustments and movements of the gate with minimal effort while installing the hinges and other hardware.

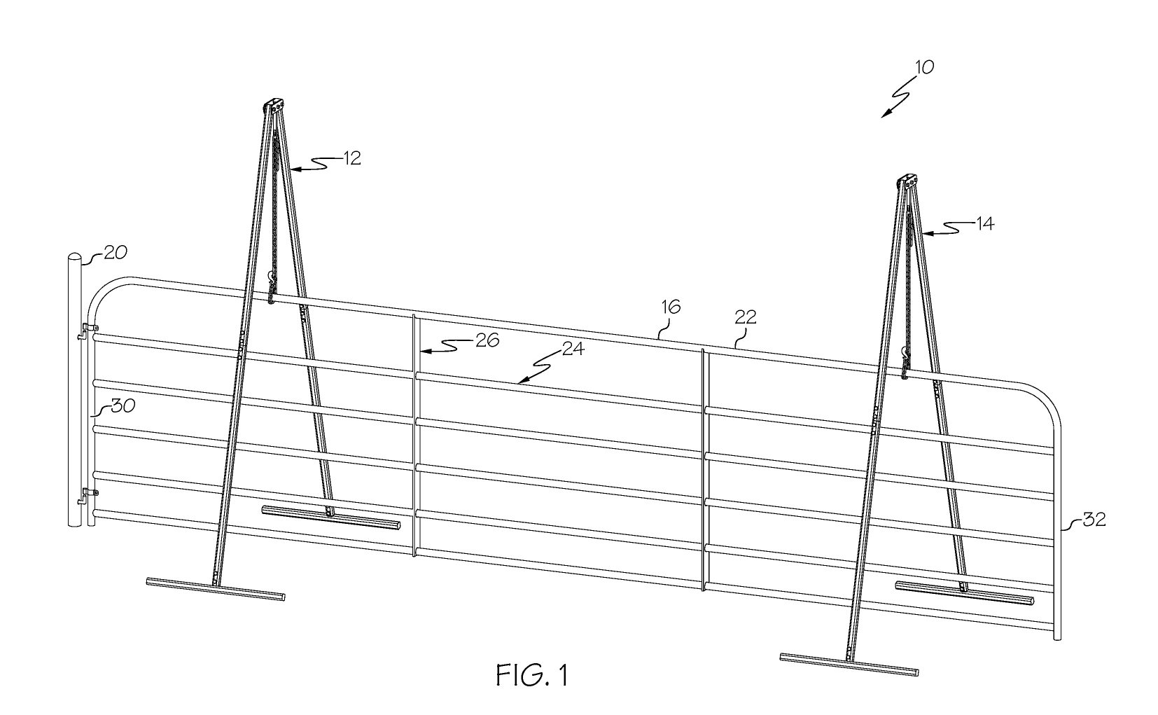

Turning now to the drawings in general and to FIG. 1 in particular, there is shown therein a system for single-handedly hanging a fence gate on a gate post or other vertical support. As used herein, “single-handedly” means being performed by a single individual. The system, designated herein by the reference number 10, comprises a pair of A-frames including a first A-frame 12 and a second A-frame 14, which may be identically formed.

FIG. 1 illustrates the system 10 being used to hang a triple-wide agricultural gate 16 on a fence post 20. The gate is a common type made of tubular steel. Generally, the gate comprises a panel 22 formed of several horizontal rails 24 supported on vertical posts 26. The vertical posts 26 on the ends define the vertical side edges 30 and 32 of the gate 16. As depicted in FIG. 1, gate 16 is positioned upright with the vertical side edge 30 adjacent the gate post 20 on which the gate is to be hingedly mounted.

As seen in FIG. 1, the A-frames 12 and 14 are positioned a distance apart and so that they straddle the upright gate 16 with one of the A-frames near each end of the gate, for a reason that will become apparent. The gate 16 is suspended in the desired position by hangers on the A-frames as described hereafter. While the dimensions of the A-frames 12 and 14 may vary, the height of the A-frames should be sufficient to straddle the fence gate 16 when the fence gate is positioned upright as shown in FIG. 1.

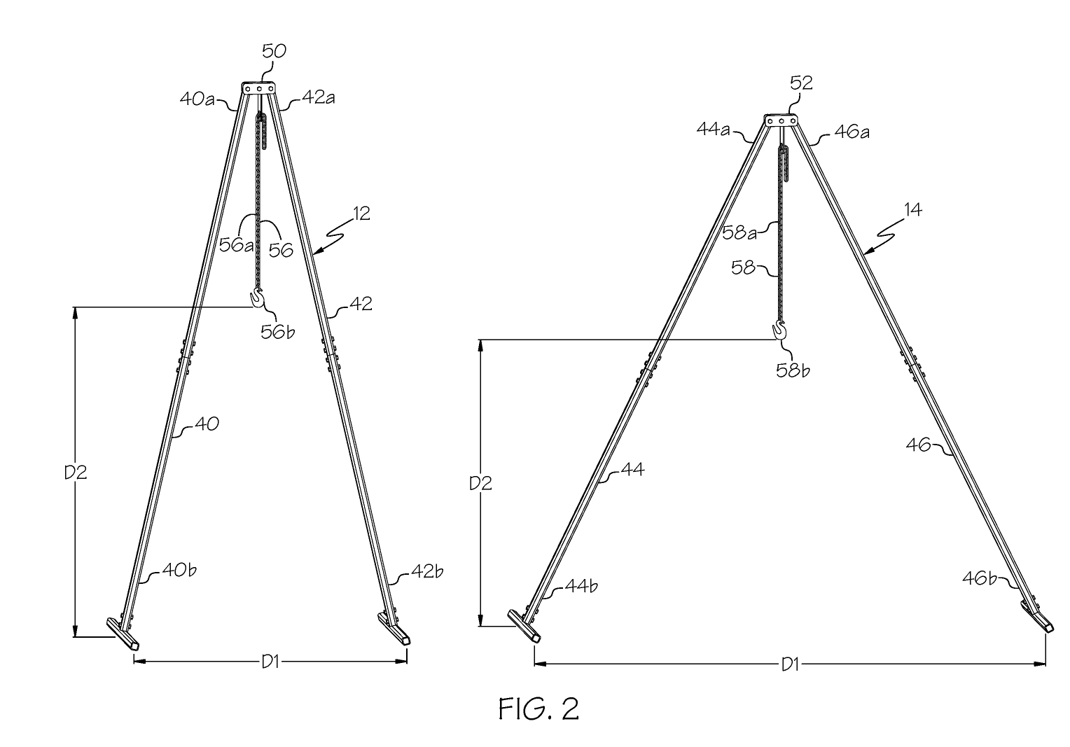

With reference now to FIG. 2, the A-frames 12 and 14 will be described in more detail. The A-frame 12 comprises a pair of legs 40 and 42. The leg 40 has a first end 40a and a second end 40b, and the leg 42 has a first end 42a and a second end 42b. The A-frame 14 comprises a pair of legs 44 and 46. The leg 44 has a first end 44a and a second end 44b, and the leg 46 has a first end 46a and a second end 46b. The first ends 40a and 42a of the A-frame 12 are hingedly connected at an apex 50, and the first ends 44a and 46a of the A-frame 14 are hingedly connected at an apex 52. In this way, the legs 40 and 42 of the first A-frame 12 and the legs 44 and 46 of the second A-frame 14 both are movable between a closed position in which the legs are adjacent each other and an open position in which the legs diverge from the apex so that the second ends 40b and 42b and 44b and 46b of the legs are spaced further apart than the first ends 40a and 42a and 44a and 46a.

The first A-frame 12 comprises a hanger 56 suspended from the apex 50, and the second A-frame 14 comprises a hanger 58 suspended from the apex 52. Each of the hangers 56 and 58 is configured to releasably attach to the fence gate 16 when the gate is positioned upright between the legs of the A-frames. The structure of the hangers 56 and 58 may vary. In the embodiment illustrated herein, each of the hangers comprises a length of chain 56a and 58a with a hook 56b and 58b on the end. This construction is simple and economical and provides a hanger that is flexible and adjustable, as will be explained below. The hooks 56b and 58b are easily attached to and released from one of the rails 24 of the gate 16 using only one hand.

As illustrated in FIG. 2, the pivotal connection of the upper ends of the legs 40 and 42 to the apex 50 and the legs 44 and 46 to the apex 52 allow the legs to spread apart a variable distance. In FIG. 2, the distance between the second ends 40b and 42b of the legs 40 and 42 of A-frame 12 and the second ends 44b and 46b of the legs 44 and 46 of A frame 14 is designated “D1,” and the distance between the hooks 56b and 58b and the ground is designated as “D2.” As shown, the legs 40 and 42 of A-frame 12 are closer together than the legs 44 and 46 of A-frame 14. Thus, the hook 56b of A-frame 12 higher off the ground than the hook 58b of A-frame 14. It will now be apparent that the height of the hangers 56 and 58 D2 varies inversely with the distance between the second ends of each of first and second legs D1. This allows the gate to be leveled by simply maneuvering the legs of the A-frames as described more fully hereafter.

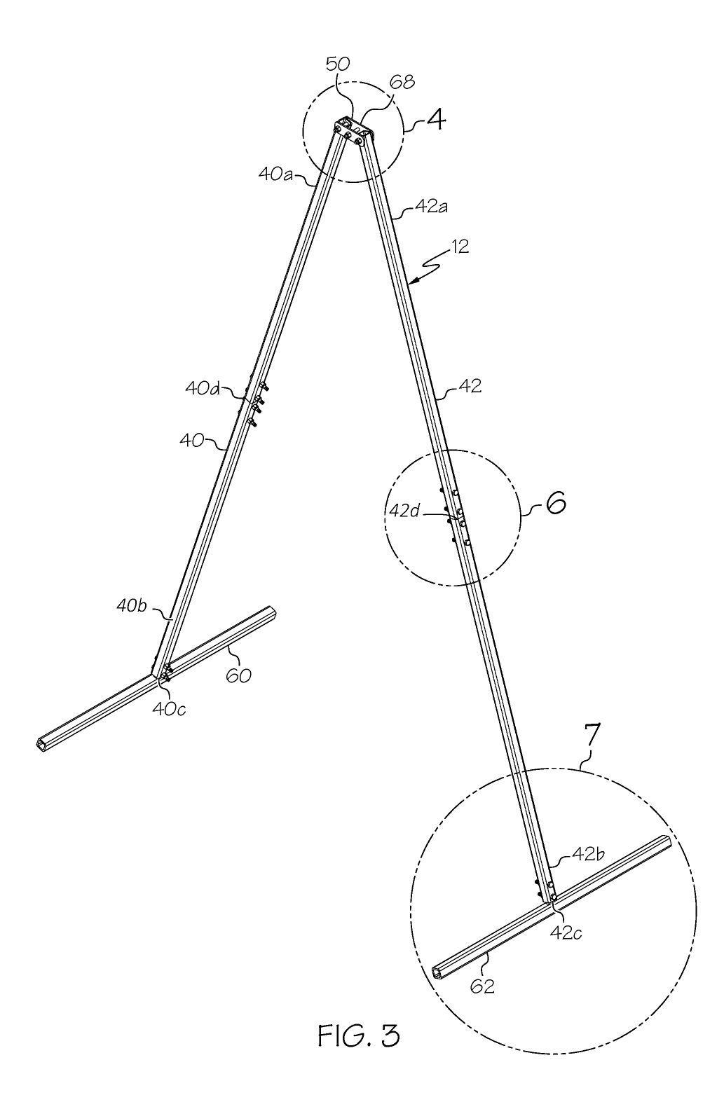

Turning now to FIGS. 3-7, a preferred construction of the A-frames will be described. As the A-frames 12 and 14 preferably are identically formed, only the A-frame 12 will be described in detail. The A-frame 12 is shown in FIG. 3. In this embodiment, each of the legs 40 and 42 includes a foot 60 and 62. The feet 60 and 62 provide a stable engagement of the legs 40 and 42 on the ground. To that end, each foot 60 and 62 may be a horizontal bar, though the configuration may vary.

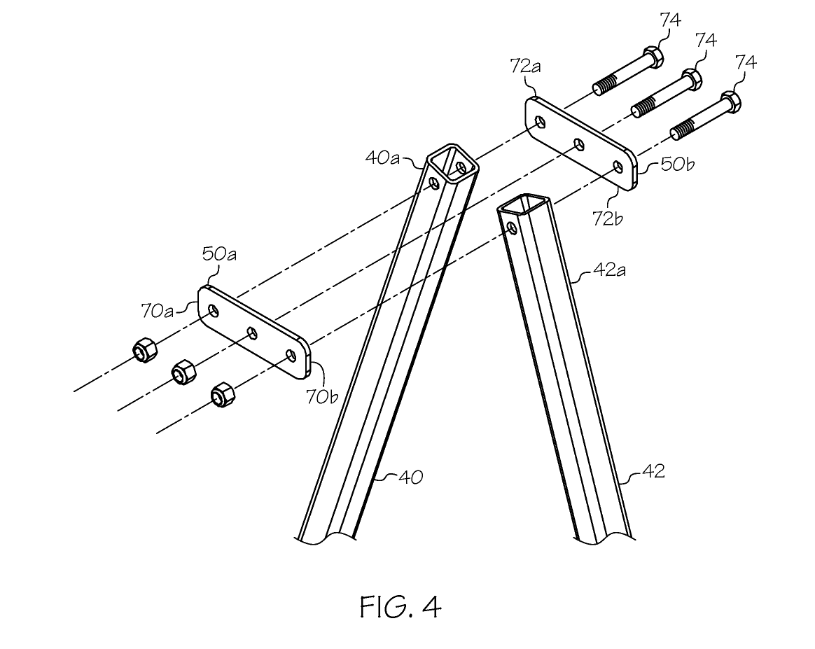

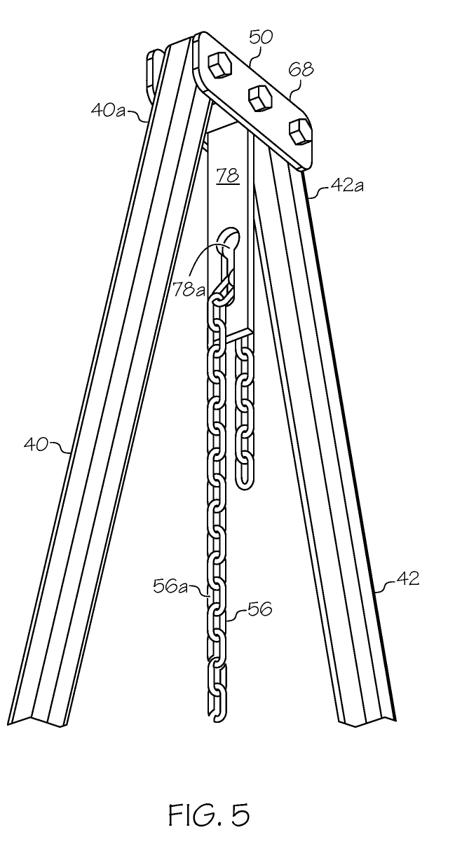

A preferred structure for the apex 50 is illustrated in FIGS. 4 and 5. The apex 50 may comprise a pair of plates 50a and 50b that together form a cross-bar 68. Each of the plates 50a and 50b has first and second ends 70a and 70b and 72a and 72b. Three bolt holes are spaced across each plate 50a and 50b. The first ends 40a and 42a of the legs 40 and 42 are pivotally connected to one of the first and second ends 70a and 70b and 72a and 72b by bolts 74.

Turning now to FIG. 5, the attachment of the hanger 56 will be explained. It is advantageous to provide the hanger with adjustability and flexibility. To that end, the apex 50 may include a hanging key bar 78. The upper end of the key bar 78 is pivotally attached to the center bolt 74; this allows the key bar 78 to swing back and forth between the legs 40 and 42. The lower end of the key bar 78 has a keyhole 78a to receive the upper end of the chain 56a. More specifically, the keyhole shape allows the upper end of the chain 56a to be pulled up and out of the key bar 78 to adjust the length of the chain and the height of the hook 56b (FIG. 2). Thus, the hanger 56 is suspended from the cross-bar 68 between the first and second ends 70a and 70b and 72a and 72b of the plates 50a and 50b of the cross-bar 68.

The A-frame 12 may be collapsible for convenient transport and compact storage. As described above, the hanger 56 can be easily removed from the key bar. The feet 60 and 62 may be removable at a joint 40c and 42c at the second ends 40b and 42b of the legs 40 and 42, as will be described. Each of the legs 40 and 42 may comprise two elongate members that are releasably connected to each other at a joint 40d and 42d. In this way, the feet can be removed and the legs taken apart to pack and store the disassembled components.

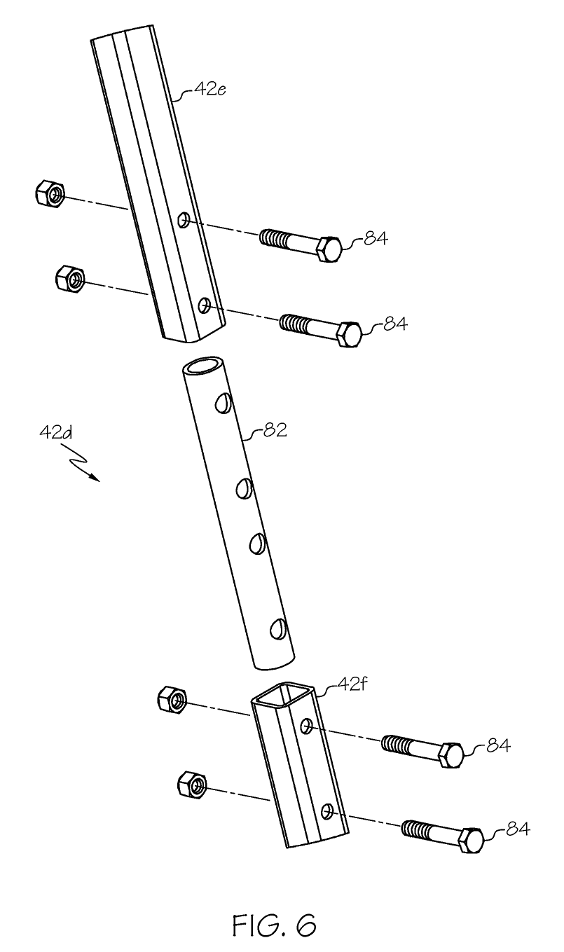

FIG. 6 illustrates a convenient structure for the leg joints 40d and 42d. As the legs 40 and 42 will be similarly formed, only the joint 42d is shown and described in detail. The leg 42 may comprise two elongate members 42e and 42f that may be of equal length and preferably are formed of tubular metal that are releasably connected to each other. In the exemplary structure, the adjoining ends of the members 42e and 42f have bolt holes and the leg 42 further comprises an inner connecting rod 82 with bolt holes that align with the bolt holes in the adjoining tubular members. Bolts 84 connect the leg members 42e and 42f to the rod 82 forming a sturdy and well-aligned connection that can be easily assembled and disassembled.

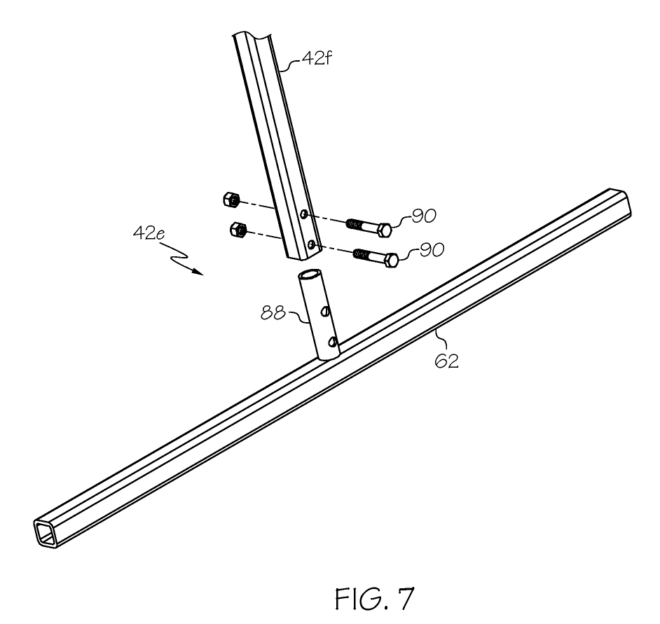

FIG. 7 illustrates a suitable joint 42c for connecting the foot 62 to the second end 42b of the leg 42. As indicated, the leg member 42f is formed of tubular metal, and the end may have bolt holes. The foot 62 is provided with an extension rod 88 also provided with bolt holes alignable with the holes in the leg member 42f. Thus, bolts 90 connect the leg member 42f to the rod 88 forming a sturdy and well-aligned connection that can be easily assembled and disassembled, as desired.

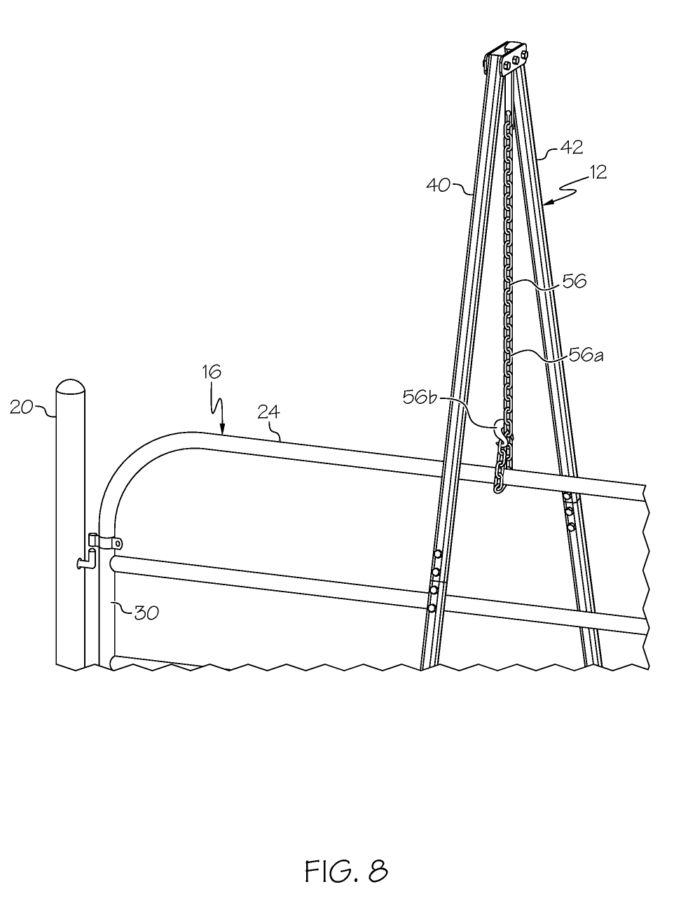

Having described a preferred structure for the A-frames 12 and 14, use of the system 10 now will be explained with reference again to FIG. 1 and now also to FIG. 8. First, the gate 16 and the system 10 are delivered to the site of installation. The fence gate 16 is positioned upright with the vertical side edge 30 adjacent the gate post 20. The hinges and other hardware are placed at the ready.

Next, the A-frames 12 and 14 are positioned a distance apart so that each will straddle the fence gate 16. It will be appreciated that, depending on the preference of the installer, this positioning of the A-frames and the gate may be reversed. That is, the A-frames 12 and 14 may be positioned first and then the gate 16 may be slid into position under the standing A-frames.

Next, the gate 16 is suspended from the hangers 56 and 58. More specifically, as seen best in FIG. 8, the chain 56a may be looped around one of the rails 24 and then hooked to itself. The gate 16 is leveled to ensure proper alignment of the hinges (not shown). The A-frame 12 nearest the gate post is adjusted to achieve the correct height relative to the hinge hardware on the gate post 20; that is, the legs 40 and 42 of the A-frame are moved closer together or farther apart to raise or lower the hanger 56 and the gate 16 attached to it. Then, the A-frame 14 furthest from the gate post 20 is adjusted to ensure that the gate 16 is level; again, the distance between the legs 44 and 46 of the A-frame 14 is adjusted to raise or lower the hanger 58 and the gate 16 attached to it.

Once the gate 16 is suspended in the correct position, the hinges are attached and the installation is complete. It will also be apparent now that, because of the flexibility of the chain, the gate 16 swings freely between the A-frames. Thus, the gate 16 can be moved in all directions, including side-to-side as viewed in FIG. 1, while attaching the hinge members.

Once the hardware is attached, the hangers 56 and 58 are detached from the gate 16, and the A-frames 12 and 14 are simply lifted out of the way. Thus, the present invention provides a method for single-handedly hanging a gate of any size.

While the system and method of the present invention has been described in the context of agricultural gates commonly used on farms and ranches, its application is not so limited. The present invention may be useful for other gates for commercial, industrial, and residential fencing and is especially advantageous for the “do-it-yourselfer” who needs to hang a gate that is extra wide or heavy or both. The simple construction of the A-frames makes production of the A-frames cost effective. Ideally, the frames are made of tubular metal, making them sturdy but lightweight. Still further, the hinged apex and the collapsible legs and feet allow the A-frames to be transported easily in the bed of a pickup and disassembled for convenient storage.

The embodiments shown and described above are exemplary. Many details are often found in the art and, therefore, many such details are neither shown nor described herein. It is not claimed that all of the details, parts, elements, or steps described and shown herein are newly invented. Changes may be made in the details, especially in matters of shape, size, and arrangement of the parts, within the principles of the invention to the full extent indicated by the broad meaning of the terms in the attached claims. The description and drawings of the specific embodiments herein do not point out what an infringement of this patent would be, but rather provide non-limiting examples of how to use and make the invention. Likewise, the abstract is neither intended to define the invention, which is measured by the claims, nor is it intended to be limiting as to the scope of the invention in any way. The limits of the invention and the bounds of the patent protection are measured by and defined in the following claims.

What is claimed is:

1. A system for single-handedly hanging a fence gate on a vertical support, the system comprising:
a first A-frame comprising:
a pair of legs, each one of the pair of legs having a first end and a second end;
wherein the first ends of each one of the pair of legs are hingedly connected at an apex so that the legs are movable between a closed position in which the legs are adjacent each other and an open position in which the legs diverge from the apex so that the second ends of the legs are spaced further apart than the first ends of the legs;
wherein the height of the first A-frame is sufficient to straddle the fence gate when the fence gate is positioned upright;
a hanger suspended from the apex, the hanger configured to releasably attach to the fence gate when the fence gate is positioned upright;
wherein the height of the hanger varies inversely with the distance between the second ends of each of first and second legs; and
a second A-frame comprising:
a pair of legs, each one of the pair of legs having a first end and a second end;
wherein the first ends of each one of the pair of legs are hingedly connected at an apex so that the legs are movable between a closed position in which the legs are adjacent each other and an open position in which the legs diverge from the apex so that the second ends of the legs are spaced further apart than the first ends of the legs;
wherein the height of the second A-frame is sufficient to straddle the fence gate when the fence gate is positioned upright;
a hanger suspended from the apex, the hanger configured to releasably attach to the fence gate when the fence gate is positioned upright;
wherein the height of the hanger varies inversely with the distance between the second ends of each of first and second legs.

2. The gate hanging system of claim 1 wherein each of the first and second A-frames further comprises a foot on the second end of each of the pair of legs.

3. The gate hanging system of claim 2 wherein each of the feet comprises a horizontal bar.

4. The gate hanging system of claim 2 wherein each of the feet is removable.

5. The gate hanging system of claim 1 wherein the first and second A-frames are the same size.

6. The gate hanging system of claim 1 wherein the hanger comprises a length of chain having a first end and a second end and a hook on the second end and wherein the first end of the chain is pivotally connected at the apex.

7. The gate hanging system of claim 1 wherein the apex of each of the first and second A-frames comprises a cross-bar.

8. The gate hanging system of claim 7 wherein the cross-bar has first and second ends, wherein the first ends of each of the pairs of legs of each of the first and second A-frames are pivotally connected to one of the first and second ends of the cross-bar, and wherein the hanger is suspended from the cross-bar between the first and second ends.

9. The gate hanging system of claim 8 wherein the hanger of the each of the first and second A-frames comprises a length of chain having a first end and a second end and a hook on the second end and wherein the first end of the chain is pivotally connected at the apex.

10. The gate hanging system of claim 1 wherein each of the first and second A-frames is collapsible.

11. The gate hanging system of claim 10 wherein each of the pair of legs of each of the first and second A-frames comprises two elongate members that are releasably connected to each other.

12. The gate hanging system of claim 11 wherein each of the first and second A-frames further comprises a removable foot on the second end of each of the pair of legs.

13. A method for single-handedly hanging a fence gate on a vertical support using the gate hanging system of claim 1, wherein the fence gate comprises a panel with a vertical side edge, the method comprising:
positioning the fence gate upright with the vertical side edge of the fence gate adjacent the vertical support;
positioning the first and second A-frames a distance apart so that each will straddle the fence gate when the vertical side edge of the fence gate is adjacent the vertical support;
suspending the fence gate from the hangers of the first and second A-frames;
leveling the gate by adjusting the distance between the pair of legs of at least one of the first and second A-frames; and
connecting the first end of the gate to the vertical support.

14. The method of claim 13 wherein the step of positioning the fence gate is carried out prior to the step of positioning the first and second A-frames.

15. A method for single-handedly hanging a fence gate on a vertical support, wherein the fence gate comprises a panel with a vertical side edge, the method comprising:
positioning the fence gate upright with the vertical side edge of the fence gate adjacent the vertical support;
positioning first and second A-frames a distance apart so that each will straddle the fence gate when the vertical side edge of the fence gate is adjacent the vertical support;
wherein each of the first and second A-frames comprises a pair of legs, wherein each of the pair of legs has an upper end and a lower end, wherein the upper ends of the pair of legs are hingedly connected at an apex so that the distance between the lower ends of the pair of legs can be adjusted;
suspending the fence gate between the legs of the first and second A-frames;
leveling the gate by adjusting the distance between the lower ends of the pair of legs of at least one of the first and second A-frames; and
connecting the vertical side edge of the gate to the vertical support.

14. The method of claim 13 wherein the step of positioning the fence gate is carried out prior to the step of positioning the first and second A-frames.
